(19) United States
(12) Patent Application Publication
(10) Pub. No.: US 2018/0292313 A1
(43) Pub. Date: Oct. 11, 2018

(54) SYSTEMS AND METHODS OF DETECTING COATINGS ON METAL SUBSTRATES

(71) Applicant: Novelis Inc., Atlanta, GA (US)

(72) Inventor: Heinrich Prinzhorn, Lower Saxony (DE)

(73) Assignee: Novelis Inc., Atlanta, GA (US)

(21) Appl. No.: 15/484,620

(22) Filed: Apr. 11, 2017

(51) Int. Cl. G01N 21/35; G01N 21/84

(52) U.S. Cl. CPC G01N 21/35; G01N 2021/8427; G01N 21/8422

(57) ABSTRACT

Disclosed herein are tools and systems for verifying the presence of coatings applied to metal substrates. Also disclosed are methods for employing the tools and systems described herein to verify coatings applied to metal substrates. The tools, systems and methods described herein can be used in metal production lines such as continuous production lines to determine whether a coating is applied to one or both sides of the metal substrate.

### TECHNICAL FIELD

The present disclosure relates to metallurgy generally and more specifically to surface coatings.

### BACKGROUND

Metal substrates can be coated for a variety of applications including aesthetics, food safety and other original equipment manufacturer (OEM) requirements. Metal processing equipment can be sensitive to coatings. It can be desirable to verify metal substrates are coated.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Disclosed are systems and methods for verifying a coating is present on a metal substrate. A method of detecting a coating on a metal substrate comprises directing an infrared radiation source toward a measurement point on a surface of a metal substrate, directing a remote temperature sensor toward the measurement point on the surface of the metal substrate, emitting infrared radiation from the infrared radiation source toward the measurement point on the surface of the metal substrate such that the infrared radiation is reflected from the measurement point, capturing the reflected infrared radiation with the remote temperature sensor, and sensing a temperature of the reflected infrared radiation with the remote temperature sensor, wherein the temperature of the reflected infrared radiation is a read temperature.

A system for detecting a coating on a metal substrate comprises an infrared radiation source configured to emit infrared radiation toward a measurement point on a surface of the metal substrate, and a remote temperature sensor configured to sense a temperature of the infrared radiation after it is reflected from the measurement point on the surface of the metal substrate. The system can be employed in metal coil production lines.

### BRIEF DESCRIPTION OF THE DRAWINGS

The specification makes reference to the following appended figures, in which use of like reference numerals in different figures is intended to illustrate like or analogous components.

FIG. 1 is a schematic of an exemplary coating verification system as described herein.

FIG. 2 is a digital image of an exemplary coating verification system as described herein.

FIG. 3 is a graph showing data verifying a coating is present on a metal substrate according to exemplary methods described herein.

FIG. 4 is a graph showing data comparing a coating present on a metal substrate and a coating that is not present on a bare metal substrate according to exemplary methods described herein.

FIG. 5 is a graph showing emissivity versus coating thickness of thin films deposited on a metal substrate according to exemplary methods described herein.

FIG. 6 is a schematic of an exemplary coating verification system as described herein.

### DETAILED DESCRIPTION

### Definitions and Descriptions

The terms “invention,” “the invention,” “this invention” and “the present invention” used herein are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” or “the” includes singular and plural references unless the context clearly dictates otherwise.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

Certain aspects and features of the present disclosure relate to systems and methods of detecting coatings on metal substrates. In some examples, a system can include an infrared radiation (IR) source and a remote temperature sensor. In some examples, a method can include exploiting differential IR reflectance of materials. For example, a metal substrate can be more reflective than a polymer film. Thus, any electromagnetic radiation reflected by the metal substrate can register a stronger signal on a measurement device. For example, infrared radiation (IR) reflected by the metal substrate can have a higher temperature reading than IR reflected by a polymer film. Thus, a higher temperature reading can indicate the metal substrate does not have a polymer coating and a lower temperature reading can indicate the metal substrate is coated with a polymer.

A system for verifying a coating on a metal substrate can include an IR source and a remote temperature sensor. The IR source can include, for example, a halogen bulb, a lamp, a ceramic heater, a heat lamp, a spot lamp, an infrared laser or other suitable IR source. The remote temperature sensor can include, for example, a pyrometer, a radiometer, an infrared thermometer, or other suitable temperature sensor.

The IR source and the remote temperature sensor can be placed adjacent to a metal substrate (e.g., a single metal strip sample or a metal coil in a production line). The IR source can be directed toward the metal substrate such that an infrared radiation (IR) emission contacts a surface of the metal substrate at a measurement point on the surface of the metal substrate. The remote temperature sensor can be directed toward the metal substrate such that IR emission reflected from the surface of the metal substrate can be read by the remote temperature sensor (i.e., the IR source and the remote temperature sensor are both aimed at the measurement point on the surface of the metal substrate).

An algorithm can be used to verify coatings on surfaces of metal substrates. Aluminum is a strong reflector of electromagnetic radiation (e.g., visible light and infrared radiation), and thus the systems and methods described herein may be particularly well suited for use with aluminum substrates. Measuring a temperature of IR reflected from a non-coated (i.e., bare) aluminum alloy can provide a calibration point (e.g., a calibration temperature) for the system described herein. The temperature of the IR reflected from the bare aluminum alloy can be a maximum possible temperature reading provided by the system described herein. The maximum possible temperature can be adjusted to allow for error (e.g., variations in coatings and radiative decay) to provide a threshold temperature. The threshold temperature can be used to indicate the presence or absence of a coating on the surface of the aluminum alloy. In some examples, the threshold temperature can be from about 10% of the calibration temperature to about 99% of the calibration temperature (e.g., from about 85% to about 95%, from about 80% to about 90%, or from about 87.5% to about 92.5%). For example, the threshold temperature can be about 10% of the calibration temperature, about 15% of the calibration temperature, about 20% of the calibration temperature, about 25% of the calibration temperature, about 30% of the calibration temperature, about 35% of the calibration temperature, about 40% of the calibration temperature, about 45% of the calibration temperature, about 50% of the calibration temperature, about 55% of the calibration temperature, about 60% of the calibration temperature, about 65% of the calibration temperature, about 70% of the calibration temperature, about 75% of the calibration temperature, about 80% of the calibration temperature, about 85% of the calibration temperature, about 90% of the calibration temperature, about 95% of the calibration temperature, about 99% of the calibration temperature, or anywhere in between.

In some examples, the exemplary system described herein can emit IR radiation at the surface of the metal substrate and measure a temperature (i.e., a read temperature) and employ the read temperature to determine a presence or an absence of a coating on the surface of the metal substrate. In some cases, coatings applied to metal substrates (e.g., aluminum alloys) are less reflective than the metal substrate. Thus, coated metal substrates can reflect less energy than bare metal substrates providing a lower temperature measurement. In some cases, the read temperature can be compared to the threshold temperature to determine the presence or the absence of a coating on the surface of the metal substrate. As mentioned above, the threshold temperature is less than the calibration temperature (i.e., the temperature of IR reflected from the surface of the bare metal substrate), thus a read temperature greater than the threshold temperature can indicate an absence of a coating on the surface of the metal substrate. In some further examples, a read temperature less than the threshold temperature can indicate a coating is present on the surface of the metal substrate.

In some aspects, the exemplary system described herein can be placed in a metal coil production line, such as a continuous processing line, at any point following a coating procedure (e.g., lacquering and curing, electrocoating and paint baking, painting and paint baking, or any suitable coating procedure). For example, the exemplary system can be placed adjacent to a slitter, a roll coater, a bath, an inspection cabin, a coiler, a de-coiler, or a re-coiler.

In some further examples, the exemplary system described herein can be placed adjacent to a first side of the metal substrate. Optionally, the exemplary system described herein can be placed adjacent to a first side and/or a second side of the metal substrate. For example, the exemplary system described herein can be placed above and/or below a metal coil in a continuous production line to verify coatings on the first side, the second side, or both sides of the metal coil.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

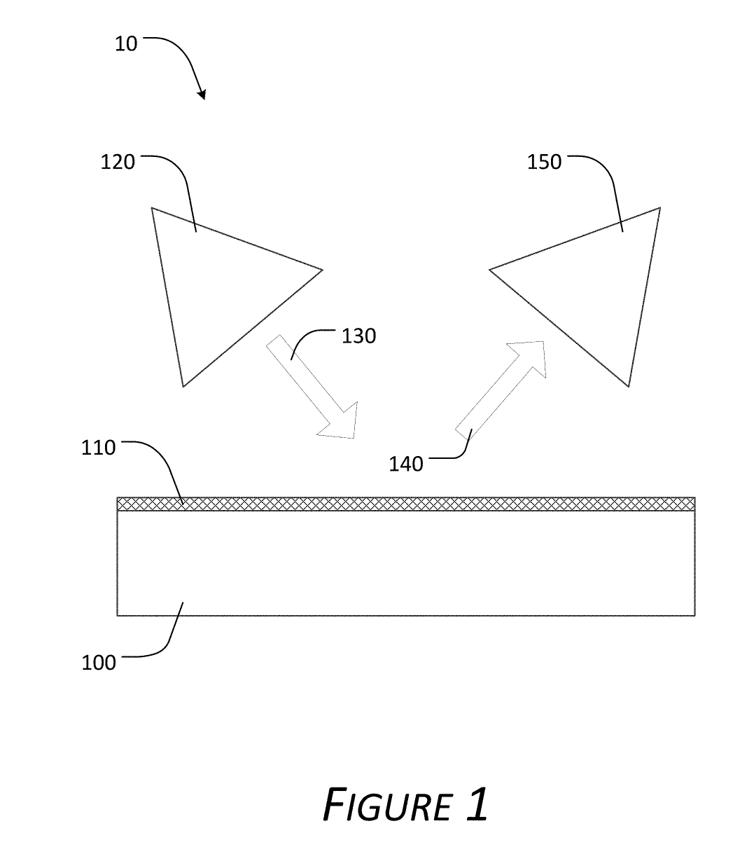

FIG. 1 is a schematic diagram of a noncontact coating verification system 10 according to one example. The schematic is not to scale; instead, dimensions are exaggerated for clarity. An aluminum alloy 100 having a coating 110 disposed on at least one surface of the aluminum alloy 100 is passed under a heat source 120. The heat source 120 emits infrared radiation (IR) 130 toward the aluminum alloy 100 and coating 110. The heat source 120 can be positioned above the aluminum alloy 100 and coating 110 at a suitable angle (e.g., from about 1° to about 90°) such that the infrared radiation can be reflected by the aluminum alloy 100 and coating 110 at a second suitable angle (e.g., from about 90° to about 179°) such that the reflected IR 140 can be recorded by a temperature sensor, such as a pyrometer 150. The pyrometer 150 can report a temperature of the reflected IR 140. In some examples, the heat source 120 and/or the temperature sensor 150 are positioned so they do not contact the metal substrate. For example, the heat source 120 and/or the temperature sensor 150 may be positioned at a distance of greater than approximately 10 cm (such as greater than 20 cm or greater than 100 mm) from the surface of the aluminum alloy 100 or other metal substrate. In this way, the system will not risk scratching or otherwise damaging the metal substrate.

In some cases, the system 10 can be calibrated by first using the pyrometer 150 to measure a temperature of the reflected IR 140 from a non-coated aluminum alloy 100. The temperature reading from the non-coated alloy (i.e., a calibration temperature) can be a maximum reportable temperature. A temperature reading of the reflected IR 140 that is about 10% to about 99% of the calibration/maximum reportable temperature (i.e., adjusted for possible error) can provide a threshold temperature that can indicate the aluminum alloy 100 is not coated. A temperature reading of less than the threshold temperature can indicate a coating 110 is present on the aluminum alloy 100.

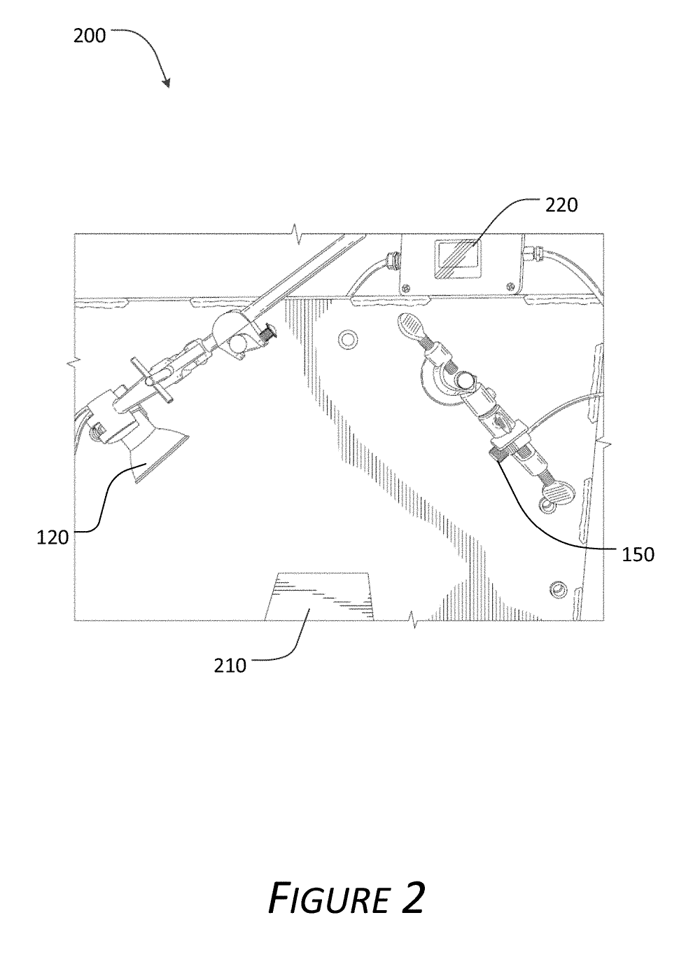

FIG. 2 shows an exemplary system 200. An aluminum alloy sample 210 is placed under the heat source 120 (e.g., a halogen lamp) and the pyrometer 150. A display 220 displays a temperature of the reflected IR (not visible). In some examples, the calibration temperature can be about 150° C. and a temperature of about 120° C. or less can indicate the coating is present.

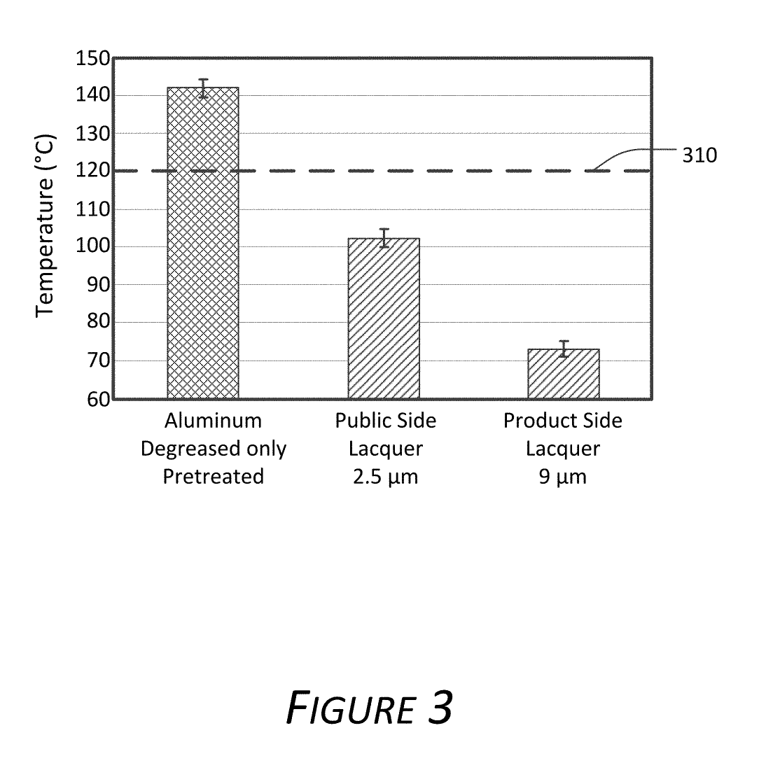

FIG. 3 is a graph showing an exemplary algorithm for verifying a coating is present on a metal substrate according to systems and methods described herein. A calibration temperature can be provided by recording a temperature of the reflected IR 140 from an aluminum alloy 100 that is not coated. The calibration temperature can be adjusted to allow for acceptable error. For example, the reflected IR from a non-coated aluminum alloy exhibited a temperature of about 141° C. (referred to as “Aluminum Degreased only Pretreated,” left histogram) and the calibration temperature reading was adjusted about 15%, providing a threshold temperature of about 120° C. The threshold temperature 310 can indicate a maximum possible temperature reading from a coated aluminum alloy 100. Coatings 110 can be less reflective than the aluminum alloys 100, thus the reflected IR 140 can contain less energy and thus register a lower read temperature than reflected IR 140 from a non-coated aluminum alloy 100. Evident in FIG. 3 are lower read temperature readings from coated aluminum alloy samples (referred to as “Public Side Lacquer 2.5 μm,” center histogram and “Product Side Lacquer 9 μm,” right histogram).

Also evident in FIG. 3, the exemplary algorithm can be employed to determine thickness of coatings applied to the surface of metal substrates. Thicker coatings can further reduce energy reflected from the surface of the metal substrate and thus register lower read temperatures than thinner coatings.

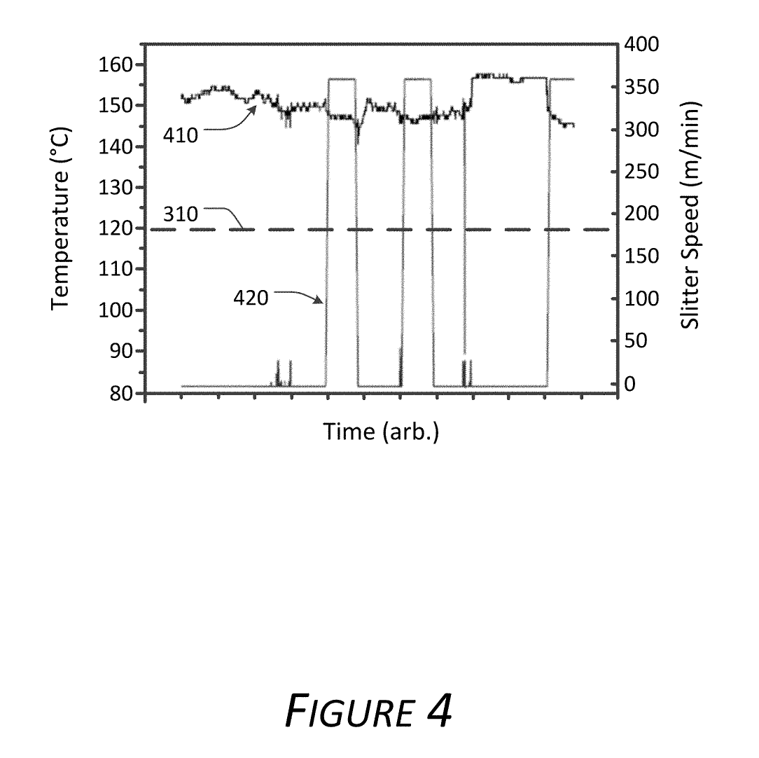

FIG. 4 shows a graph comparing a bare aluminum alloy and a coated aluminum alloy measured by a system as described herein. The system was placed into a production line of the bare aluminum alloy and placed into a production line of the coated aluminum alloy. The bare aluminum alloy 410 consistently registered temperatures greater than the threshold temperature 310 (indicated by a dashed line at about 120° C.). Passing a coated aluminum alloy 420 through the system demonstrated the ability of the system described herein to indicate coated areas and bare areas on the aluminum alloy. Temperature readings from the coated aluminum alloy 420 fluctuate consistently with coated and uncoated areas of the aluminum alloy. Lower readings (e.g., about 83° C.) indicated coated areas and higher readings (e.g., about 157° C.) indicate bare areas of the aluminum alloy.

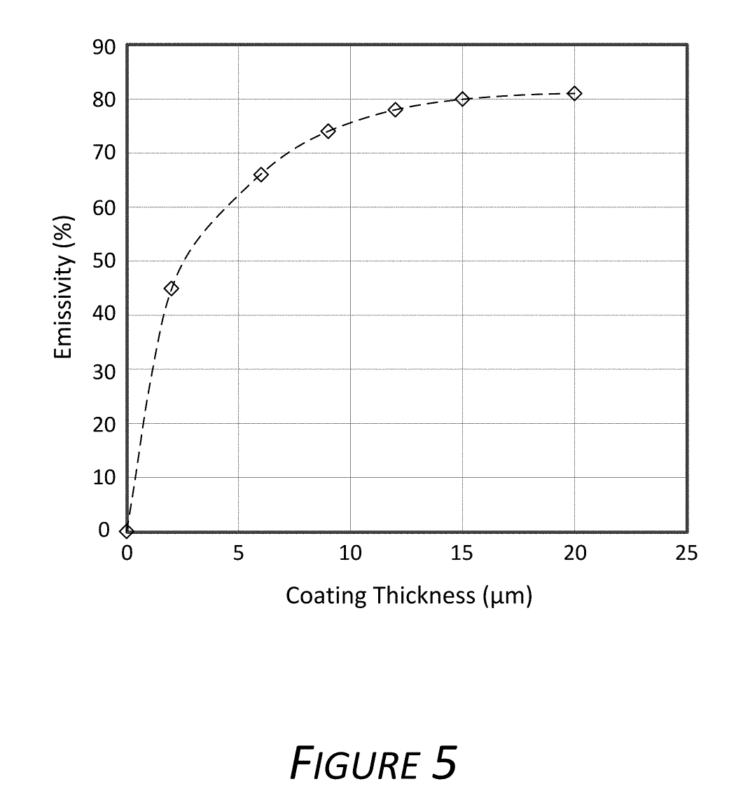

FIG. 5 shows a graph comparing coating thickness to emissivity of an exemplary aluminum alloy surface. A very low emissivity (e.g., from about 1% to about 5%), can indicate a non-coated aluminum alloy surface. Variables including alloy class and surface roughness can affect the emissivity. The emissivity values can increase rapidly with increasing film thickness, demonstrating a high sensitivity of an exemplary system described herein for detecting thin coating layers on an aluminum alloy surface. Comparing coating thickness to emissivity of an exemplary aluminum alloy surface can provide a calibration curve for theoretical examination of the threshold temperature 310.

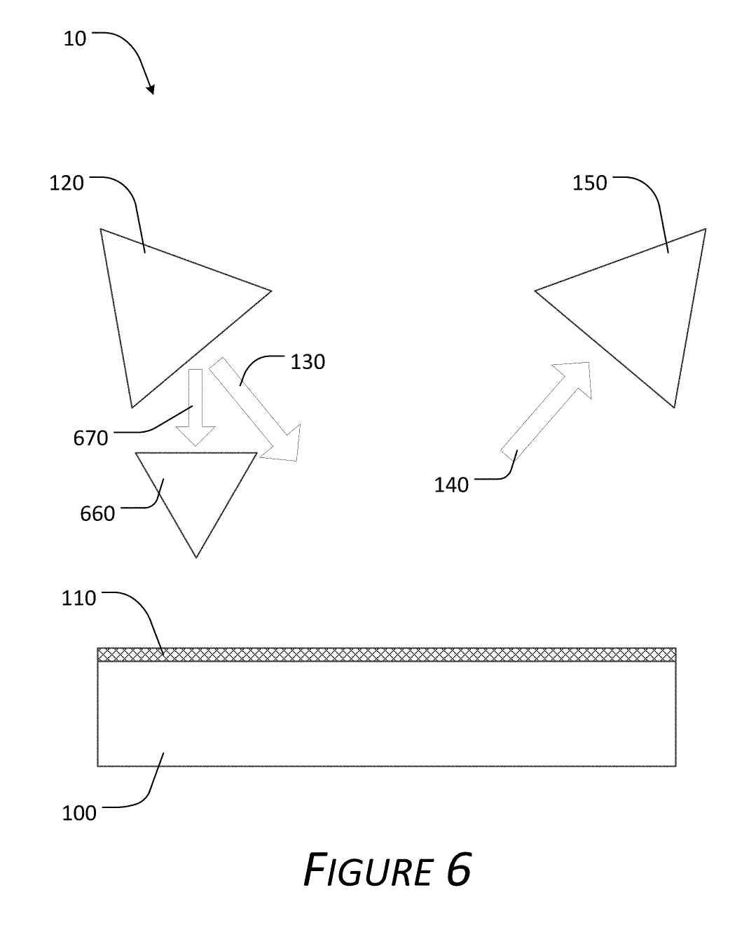

In some further examples, a second temperature sensor 660 (see FIG. 6) can measure a raw output 670 of the heat source 120. Performing in situ division of a measured temperature from the temperature sensor 150 by a measured temperature from the second temperature sensor 660 can provide real-time analysis of a coated aluminum alloy. Real-time analysis of the coated aluminum alloy can eliminate any need for calibration from non-coated substrates.

In some examples, employing the exemplary system described herein (e.g., a heat source and a pyrometer) can provide a very low cost alternative for thin film on metal surfaces verification. Additionally, the exemplary system described herein can provide a highly sensitive and highly precise thin film on metal surfaces verification system that does not contact the metal surfaces and can preserve the thin film while verifying its presence. A low cost, high sensitivity and high precision noncontact thin film verification system can further provide protection to metal processing equipment that can be damaged when an expected thin film is not present on a metal surface. In some further examples, the exemplary system described herein can be used to measure thickness of the thin film through development of an exemplary calibration curve as shown in FIG. 5.

In some further examples, the systems and methods described herein provide a simple, fast and compact process to measure a thin film on a metal substrate. For example, the systems and methods described herein can exploit a natural strong reflection of infrared radiation that is inherent to aluminum and aluminum alloys. In some non-limiting examples using the natural strong reflection of aluminum and aluminum alloys can provide a simple system wherein there is no need for complex optics often found in thin film measurement systems. In some non-limiting examples, using the natural strong reflection of aluminum and aluminum alloys can provide a fast system wherein reported measurements are provided by light (i.e., infrared radiation), electronics, and a simple calculation. In some non-limiting examples using the natural strong reflection of aluminum and aluminum alloys can provide a very compact system or, for example, a large system created from an array of the very compact system. Thus, the systems and methods described herein can measure thin films on 100% of the metal substrate.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

What is claimed is:

1. A method of detecting a coating on a metal substrate comprising:
directing an infrared radiation source toward a measurement point on a surface of the metal substrate;
directing a remote temperature sensor toward the measurement point on the surface of the metal substrate;
emitting infrared radiation from the infrared radiation source toward the measurement point on the surface of the metal substrate such that the infrared radiation is reflected from the measurement point;
capturing the reflected infrared radiation with the remote temperature sensor; and
sensing a temperature of the reflected infrared radiation with the remote temperature sensor, wherein the temperature of the reflected infrared radiation is a read temperature.

2. The method of claim 1, further comprising determining a calibration temperature, wherein the calibration temperature is a temperature of the infrared radiation reflected from a non-coated metal substrate.

3. The method of claim 2, further comprising determining a threshold temperature, wherein the threshold temperature is 10% to 99% of the calibration temperature.

4. The method of claim 3, further comprising comparing the read temperature to the threshold temperature.

5. The method of claim 3, further comprising calculating a resultant quantity by subtracting the read temperature from the threshold temperature, wherein a resultant quantity less than or equal to zero indicates an absence of a coating and a resultant quantity greater than zero indicates a presence of a coating.

6. A system for detecting a coating on a metal substrate comprising:
an infrared radiation source configured to emit an infrared radiation toward a measurement point on a surface of the metal substrate; and
a remote temperature sensor configured to sense a temperature of the infrared radiation after it is reflected from the measurement point on the surface of the metal substrate.

7. The system of claim 6, wherein the infrared radiation source comprises a lamp, a ceramic heater, a heat lamp, a spot lamp, a halogen lamp, or an infrared laser.

8. The system of claim 6, wherein the remote temperature sensor comprises a pyrometer, a radiometer or an infrared thermometer.

9. The system of claim 6, wherein the system is positioned adjacent to the metal substrate.

10. The system of claim 9, wherein the system is positioned at a distance between 5 cm and 30 cm from the surface of the metal substrate.

11. The system of claim 6, wherein the system is positioned such that the infrared radiation source is at an angle between 1° and 90° relative to the metal substrate.

12. The system of claim 6, wherein a direction of the remote temperature sensor is aimed at the measurement point.

13. The system of claim 6, wherein the system is employed in a metal coil production line.

14. The system of claim 6, wherein the system is employed in a metal coil production line following a coating procedure.

15. The system of claim 6, wherein the system is employed in an aluminum alloy production line.
